(19) United States
(12) Patent Application Publication
(10) Pub. No.: US 2012/0041888 A1
(43) Pub. Date: Feb. 16, 2012

(54) SYSTEM AND METHOD FOR THE MANAGEMENT OF INTERACTION CHANNELS BETWEEN SOCIAL INVESTORS, AWARDEES AND RECIPIENT INSTITUTIONS

(76) Inventor: Marcelo Abreu Marques de Oliveira, Rio de Janeiro (BR)

(21) Appl. No.: 12/853,562

(22) Filed: Aug. 10, 2010

(51) Int. Cl. G06Q 99/00

(52) U.S. Cl. 705/319

(57) ABSTRACT

A system and method for the management of interaction channels between social investors, awardees and recipient institutions is described, which comprises an online platform that operates based on user profiles: Social Investor (A), Awardee (B) and Recipient Institution (C), being that said agents (A, B and C) perform interactions by means of the channels provided by the platform, in order to accomplish Solidarity Awards with the compulsory joint selection of an Awardee (B) and of a Recipient Institution (C) for the accomplishment of the Solidarity Award

### FIELD OF INVENTION

This invention concerns a system and method for the management of interaction channels between Social Investors, Awardees and Recipient Institutions. More specifically, it comprises an online platform which supports the management of interaction channels between the three main platform agents—the Social Investor, the Recipient Institution and the Awardee,—who associate themselves, primarily, through a transaction based on the inseparable binomial ‘social investment and award’, being said transaction defined as Solidarity Awards.

### Antecedents of the Invention

As a means of communication which, today, reaches a large share of the population, the Internet offers thousands of business opportunities.

Internet users have been expanding their interactions, with emphasis on communication and leisure activities, which have demonstrated an average growth trend greater than two percentage points/year in certain countries currently in the process of computerization.

According to the report New Media Fundraising: 21st Century Innovations, published by CAF, the Internet is the format with the greatest potential and reach for the collection of resources. To this effect, the use of the internet as a fundraising tool increases the potential for expansion of the social investor's base.

It is estimated that only 0.12% of the population uses the internet as means of making donations, and this percentage may reach 5.83% in 10 years. The profile of this user presents a high degree of compatibility with the profile of the small-scale social investor: college/university degree or family income above 10 minimum wages or belonging to social class A.

The state of the art describes methods and/or systems based on the Internet to promote donations or interactions with social networks without, however, approaching the concept established in this invention, which supports a transaction based on the inseparable binomial ‘social investment and award’, defined as Solidarity Awards.

Document US20080021720 describes a system and method to indicate to the user a point score based on all the donations made by an individual, plus all the donations made by those donors personally encouraged by this same individual to make said donation, plus the donations made by donors who were indirectly encouraged to make a donation, facilitating the tracking of donations.

Document US20070036287 describes a method to facilitate the interaction of institutions with celebrities by means of an interactive online environment.

Document US20070244810 describes a system that enables a user to identify a charity entity to receive a donation and identify a donation amount to be supplied for the successful performance of an operation, in which the user can select the charity entity from a list of one or more entities established by a third party, or supply information for the registration of a new entity.

Document US20060122874 describes a method and system to make a donation to a third party, in which a user performs a purchase transaction associated to a user account in a financial institution. The donation may be in the form of cash or equivalent, reward points, or others.

Document US2009192873 describes a donation platform that coordinates the interactions and transactions between the platform participants in order to facilitate the distribution of donations based on consumer purchases. This system focuses on purchasing processes, and does not contemplate the existence of the awardee as such.

Document US2004049399 describes a system and method to make an online donation to a non-profit organization, in the name of an awardee, with the remittance of a personalized card. In this system, the awardee is not offered the functionalities and interactivity in relation to the configuration and management of rewards, prizes or the experience of social contact.

Document US2007198372 describes a management system for philanthropic donations in a communications network, such as the Internet, LAN or WAN. The server maintains information on the charity projects and offers its users tools to manage information on the charity projects, management of information on the charity project, portfolios, team members, user and access information. This system refers to the management of donations, and does not allow interaction between the participating elements.

Document US2005251460 describes a method for the management of requests for donations, which includes the receipt, through a communication network, of data with respect to values for donation and a plurality of organizations selected during the online purchasing process. In this document, the selection of the institutions is made according exclusively to the donor's criteria, contrary to the system object of this invention, in which the selection of the recipient institutions is tied to the institutions indicated, suggested and even restricted by each awardee, according to the participation in the rewards offered by the same.

Document US2005004867 describes network techniques based on the management and monitoring of the donations and donation information, comprising a group management module that presents a user interface with which a donor interacts to create a particular donation group. The donation management module receives donations from electronic members safely and privately. This document describes a secure and private interface for users to create their own groups to receive donations, while the system object of this invention enables the donation of social investors to already existing charity institutions.

Therefore, the state of the art documents make reference to donation management systems or interfaces between the donor and the user group, but do not include the possibility, together with this donation, of an award (or homage) and the attribution of prizes based on the economic relevance of the social investments made—an interactivity which the present system and method for the management of interaction channels between Social Investors, Awardees and Recipient Institutions describes and claims in this request.

### Abridgment

In general terms, this invention concerns a system and method for the management of interaction channels between Social Investors, Awardees and Recipient Institutions, comprising an online platform that works based on user profiles: Social Investor (A), Awardee (B) and Recipient Institution (C), with said agents (A, B and C) performing interactions through the channels provided by the platform, so as to make Solidarity Awards with the compulsory joint selection of an Awardee (B) and of a Recipient Institution (C) for the accomplishment of the Solidarity Award.

The indivisibility of the binomial that always comprises a social investment made to an agent registered at the online platform as a Recipient Institution and an award (homage) to an agent registered at the platform as an Awardee is characteristic of the invention. These are inseparable objects within the concept of this online platform, and the relationship between them is conceptually referred to as Solidarity Award throughout the scope of this document.

Characteristic of the invention is a system and method for the management of interaction channels between Social Investors, Awardees and Recipient Institutions, which unites three agents in a Solidarity Award transaction (‘social investment and award [homage]’ binomial).

Characteristic of the invention is a system and method for the management of interaction channels between Social Investors, Awardees and Recipient Institutions that provides a ludic platform which takes on the role of disseminator of a culture of social responsibility for individuals and corporations.

Characteristic of the invention is a system and method for the management of interaction channels between Social Investors, Awardees and Recipient Institutions, which manages the relations between the Social Investor and the Recipient Institution (by means of a social investment), the Social Investor and the Awardee (by means of an award/homage), the Awardee and the Social Investor (by means of the offering of a prize or reward), the Awardee and the Recipient Institution (by means of institutional support) and the Recipient Institution and the Social Investor (by means of rendering of account).

Characteristic of the invention is a system and method for the management of interaction channels between Social Investors, Awardees and Recipient Institutions which acts as a practical, secure and transparent means of fundraising for third sector institutions, and which also allows these institutions to use customized rendering of account channels according to the profile of the Social Investor.

Characteristic of the invention is a system and method for the management of interaction channels between Social Investors, Awardees and Recipient Institutions, which provides a channel for the offering of prizes and rewards based on an accomplished Solidarity Award.

Characteristic of the invention is a system and method for the management of interaction channels between Social Investors, Awardees and Recipient Institutions, which promotes the creation of an infrastructure that maximizes the participation and representativeness of the small and average Social Investor.

### BRIEF DESCRIPTION OF FIGURES

FIG. 1 presents a schematic representation of the system, evidencing the three main agents—Social Investors (A), Awardees (B) and Recipient Institutions (C)—, their interactive relationships, the ‘Institutional Area of Support to Awardees’ agent (D) and his/her interactions with the Awardees (B).

FIG. 2 presents the flow chart for the Social Investor's (A) registration stages and actions.

FIG. 3 presents the flow chart for the Awardee's (B) registration stages and actions.

FIG. 4 presents the flow chart for the Recipient Institutions' (C) registration stages and actions.

FIG. 5 presents the flow chart for the ‘Institutional Area of Support to Awardees’ agent's (D) registration stages and actions.

### DETAILED DESCRIPTION OF THE INVENTION

For the purposes of this invention, the following terms are thus conceptualized:

a) “Social Investor” corresponds to an individual or corporate user who will make a social investment to a “Recipient Institution” and, concomitantly, make an award (render homage) to a personality, institution or artistic work (artists, personalities, institutions, entities, companies, artistic works of any nature, projects and accomplishments of any nature) of their choice, who will be identified as “Awardee”;

b) “Recipient Institution” comprises an institution, foundation, or charity organization that promotes social wellbeing, and is usually classified as belonging to the third sector;

c) “Social Investment” comprises the transfer of financial resources from the Social Investor to a Recipient Institution, subject to consideration in favor of the Social Investor;

d) “Solidarity Award” is the term used to define the binomial ‘social investment and award’. Thus, the platform admits that the user who primarily wishes to make a social investment (financial donation subject to the rendering of account) to a Recipient Institution must also make an award (render homage) and, on the other hand, also allows the user who primarily wishes to make an award (render homage), to compulsorily add the nature of social investment to said award (homage).

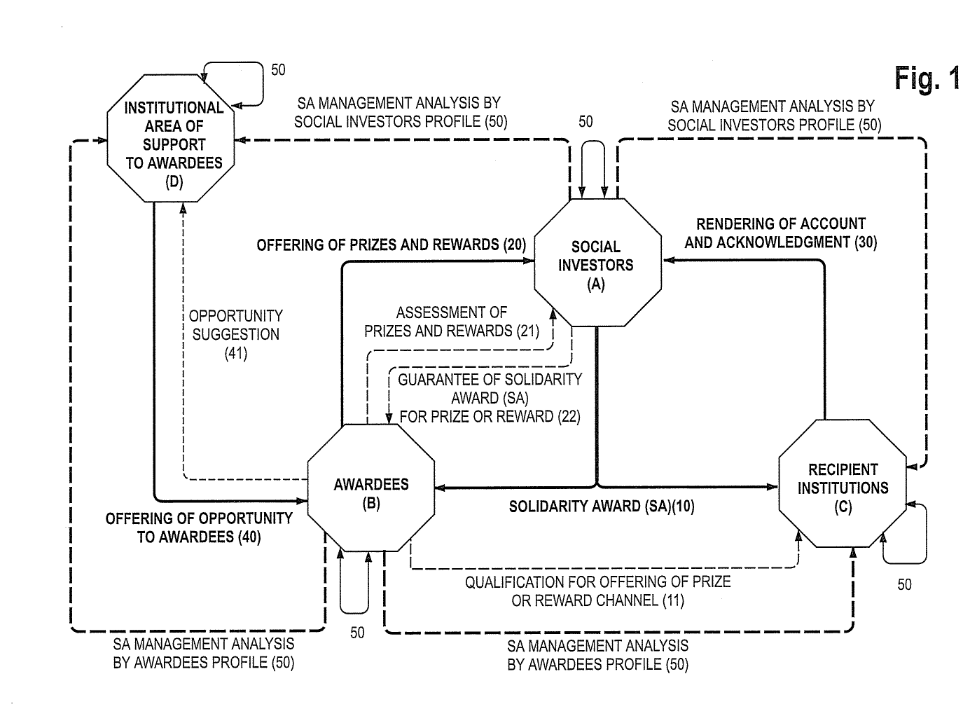

As presented in FIG. 1, the system for the management of interaction channels between Social Investors, Awardees and Recipient Institutions consists of an online platform that operates based on user profiles generically defined in this document as Social Investor (A), Awardee (B) and Recipient Institution (C), being that said agents (A, B and C) perform interactions through the channels provided by the platform, with emphasis on the Solidarity Award Channel (10) in which a single transaction immediately establishes a relationship between the three agents due to the compulsory and joint selection of both an Awardee (B) and a Recipient Institution (C) for the accomplishment of the Solidarity Award (‘social investment and award’ binomial).

The online platform includes a remote access server which stores a database referent to the registration of the system user profiles and a site with access by means of a communication network using login and password, where each user accesses his/her respective profile and/or visualizes the interactions related to his/her user profile.

The method for the management of interaction channels between Social Investors (A), Awardees (B) and Recipient Institutions (C) includes, in a first stage, the registration of the agents for access to the online platform, with the creation of a specific profile—Social Investor, Awardee or Recipient Institution.

Optionally, a user profile includes the registration of the agent denominated Institutional Area of Support to Awardees (D).

The registration of the user in a specific profile implies the registration in a database of information classified as private by default, such as name, address, e-mail, CEP (Zip Code), CPF (Individual Taxpayer Register), telephones, date of birth, gender, income range, profession, education and voluntary work in Institutions and respective details, and information that may be optionally disclosed to friends or made public, such as social network identifiers (blog, website).

The registration of the user profiles (A, B, C and D), will be subject to validations established by the online platform, by acceptance of specific adhesion conditions.

The system and method for the management of interaction channels between Social Investors, Awardees and Recipient Institutions, according to FIG. 1, comprises a group of relations between the agents previously registered at the online platform.

The interactions between the Social Investor (A) and Recipient Institution (C) occur through the Solidarity Award Channel (10), where is this Social Investor (A) makes a social investment in favor of a Recipient Institution (C) previously registered at the online platform. At the same time as the social investment is made by the Social Investor (A) to the Recipient Institution (C), this Social Investor (A), using the Solidarity Award Channel (10), interacts with an Awardee (B) in order to make his/her award (homage).

Optionally, the interaction between the Awardee (B) and the Recipient Institution (C) occurs through the Offering of Prizes and Rewards (20). In this situation, the Awardee (B) chooses to define that the participation of Social Investors (A) in a certain prize or reward is restricted to the choice of a certain group of Recipient Institutions (C), said interaction represented by the unidirectional interaction Qualification for the Offering of a Prize or Reward (11), presented in FIG. 1.

The interactions established between the Social Investor (A) and the Awardee (B) occur through the Offering of Prizes and Rewards Channel (20), where the Awardee (B) offers to the Social Investors (A) a prize or reward that the Social Investors (A) will dispute by virtue of their respective Solidarity Awards that comply with the specific prize or reward rules defined by the Awardee (B).

Through the flow referred to as ‘Assessment of Prizes and Rewards’ (21), the Awardee (B) is authorized, before effectively offering a prize or reward, to perform an assessment of the adhesion of Social Investors (A) in relation to said offer, through the Assessment of Prizes and Rewards Channel (21).

Through the flow referred to as Guarantee of Solidarity Award for Prize or Reward (22), the Social Investors (A) are authorized to confirm a minimum volume of Solidarity Awards that they wish to make for a certain proposed prize or reward. Thus, the Channel (21) ensures to the Awardee (B) an assessment of the expected performance of a certain prize or reward.

The interactions between the Social Investor (A) and the Recipient Institution (C) occur through the Rendering of Account and Acknowledgement Channel (30), in which the Recipient Institution (C) sends the consideration of the social investment made by the Investor (A), who may define the type of rendering of account (31), such as its standard, formatting, frequency, among others.

Optionally, the Recipient Institution (C) may grant the recognition (30) of the social investment made by the Social Investor (A) in the form of thanks, such as rendering this action public in different media, placing a photo of the investor (A) at the institution' headquarters, sending a postcard, among others.

Optionally, the Institutional Area of Support to Awardees agent (D) interacts with the Awardee (B) through the Offering of Opportunity to Awardees Channel (40). This Channel (40) allows the company or organization belonging to the Institutional Area of Support to Awardees (D) to provide a service, infrastructure or product without burden to an Awardee (B) that supports or enables the offering of a prize or reward to the Social Investors (A), as previously described in relation to the Offering of Prizes and Rewards Channel (20).

Optionally, the Opportunity Suggestion Channel (41) establishes itself between the Awardee (B) and the Institutional Area of Support to Awardees (D), where the Awardee (B) can suggest opportunities of his/her interest that depend on a service, infrastructure, or product to be provided without burden by a company or organization registered at the Institutional Area of Support to Awardees (D). The suggested is opportunity is bound to the obligation of an offering of a prize or reward to the Social Investors (A) as previously described in the Offering of Prizes and Rewards Channel (20).

The online platform enables management analysis tools (50) that supply organized data with the possibility of defining filters by category or type or profile for each of the platform agent types or for the referential of a specific participating agent:

In the view of the Institutional Area of Support to Awardees (D), the following items are hierarchically visualized: categories of Awardees (films, singers, works, among others), Awardee (B), type of prize (e.g.: social contact at a public event, social contact at a private event, prizes for public use and prizes for private use), prize, activity profile of the Recipient Institution, Recipient Institution (C) and socio-economic profile of the Social Investor, Social Investor (A).

In the view of the Awardee (B), the following items are hierarchically visualized: category of Awardee, Awardee (B), type of prize, prize, activity profile of the Recipient Institution, Recipient Institution (C), socio-economic profile of the Social Investor and Social Investor (A)

In the view of the Recipient Institution (C), the following items are hierarchically visualized: category of Awardee, Awardee (B), type of prize, prize, socio-economic profile of the Social Investor, and Social Investor (A).

In the view of the Social Investor (A), the following items are hierarchically visualized: category of Awardee, Awardee (B), type of prize, prize, activity profile of the Recipient Institution, Recipient Institution (C), social-economic profile of the Social Investor and Social Investor (A).

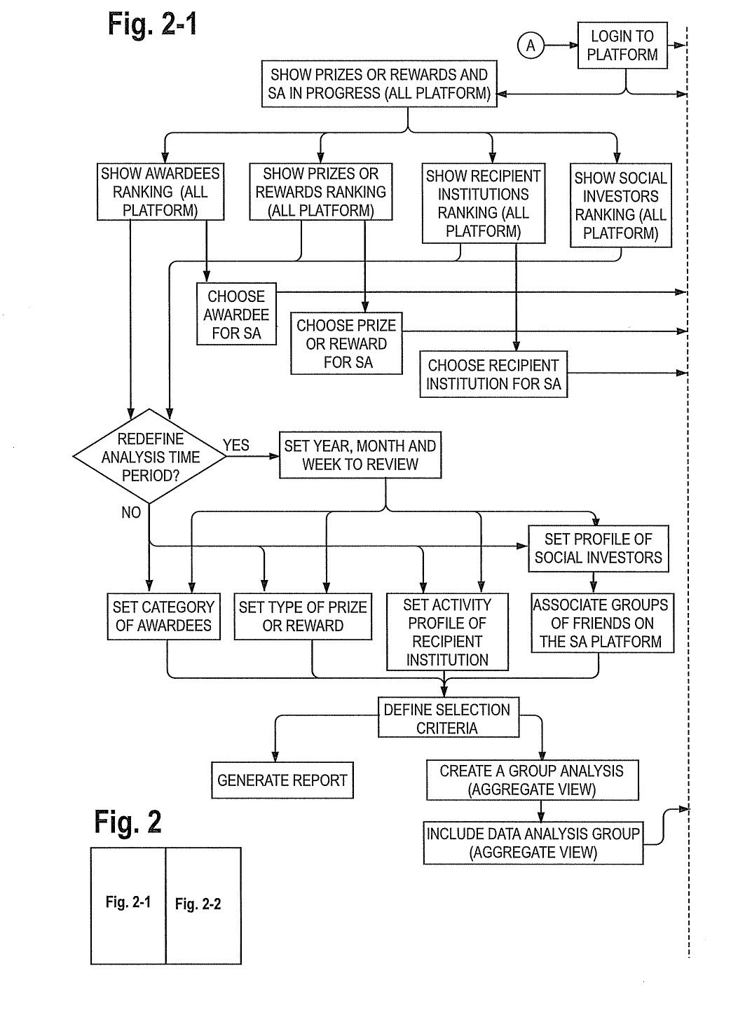

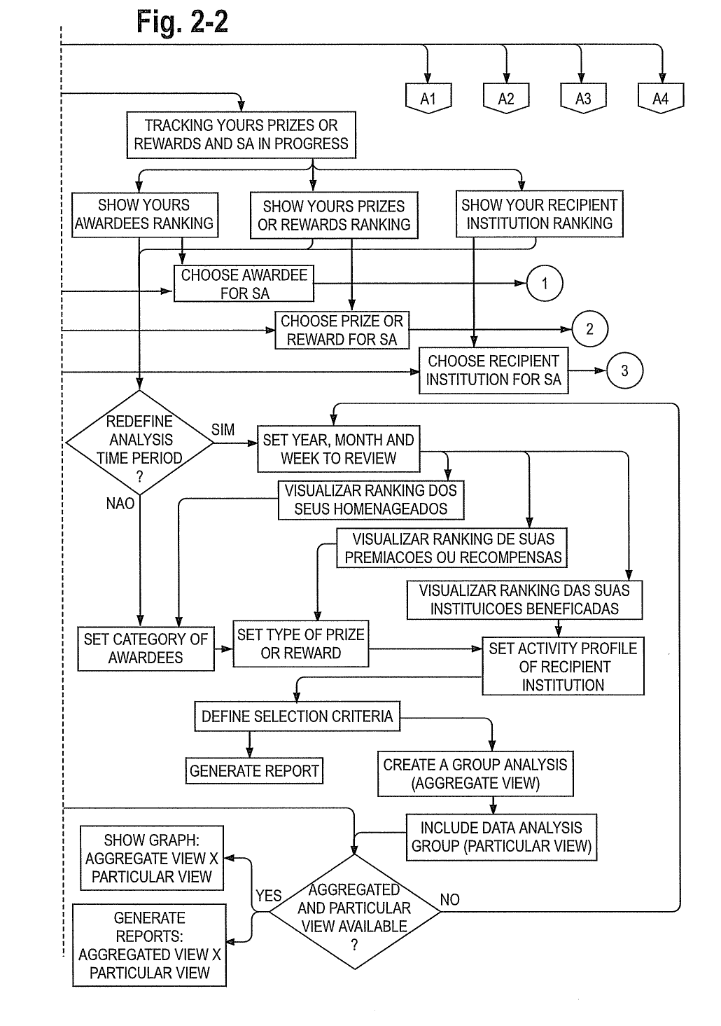

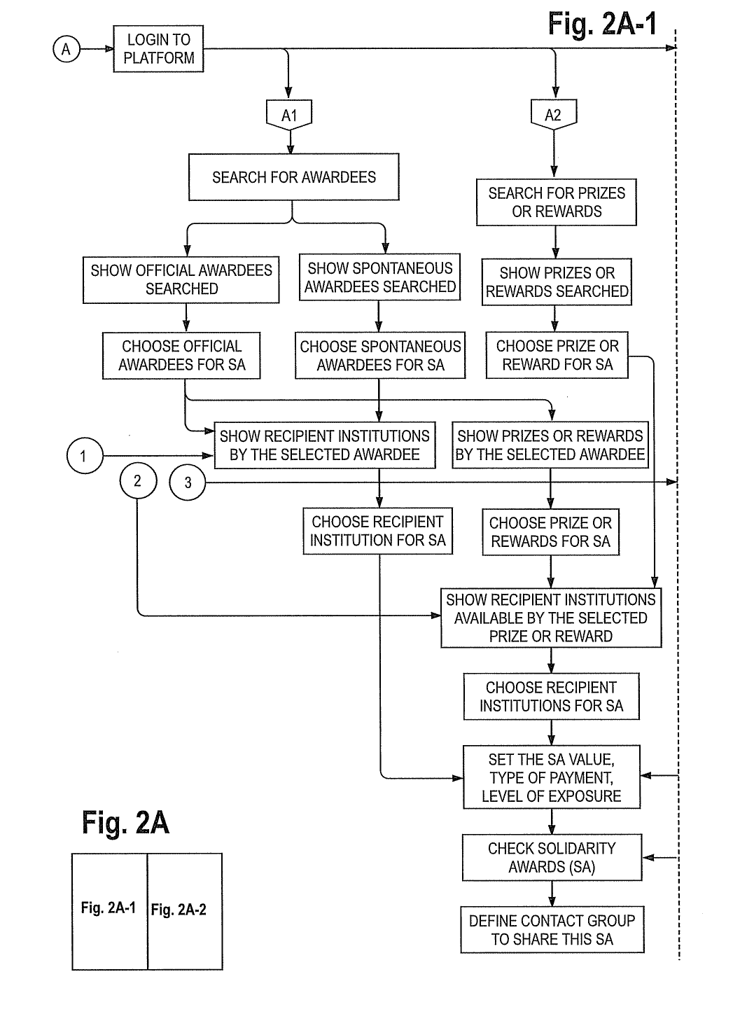

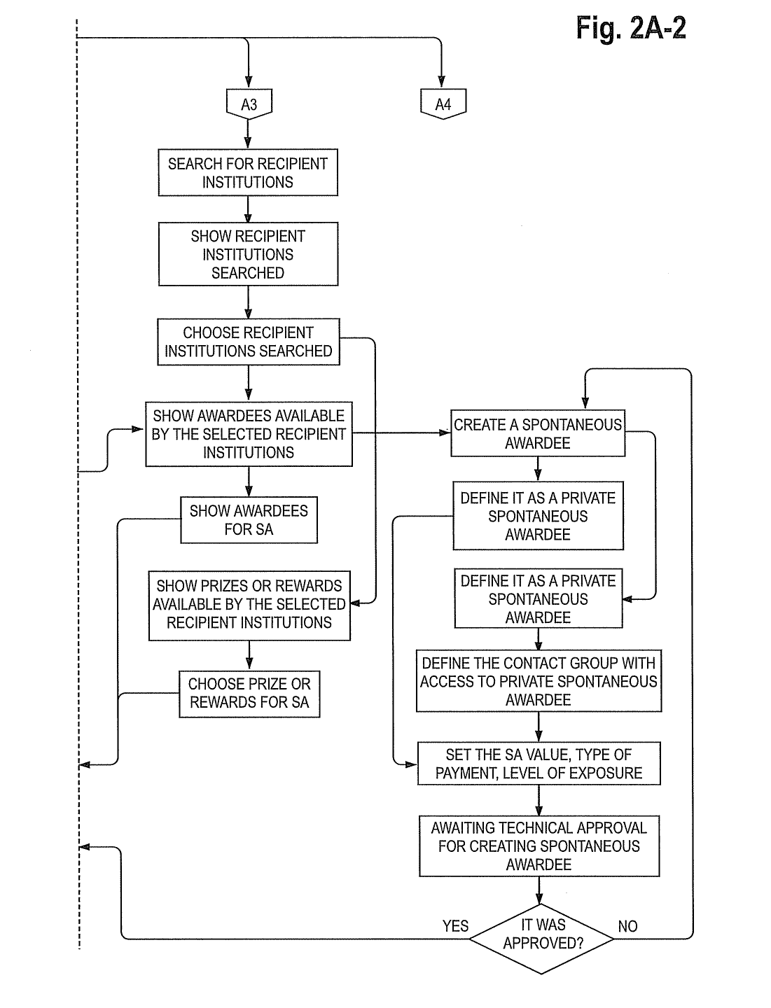

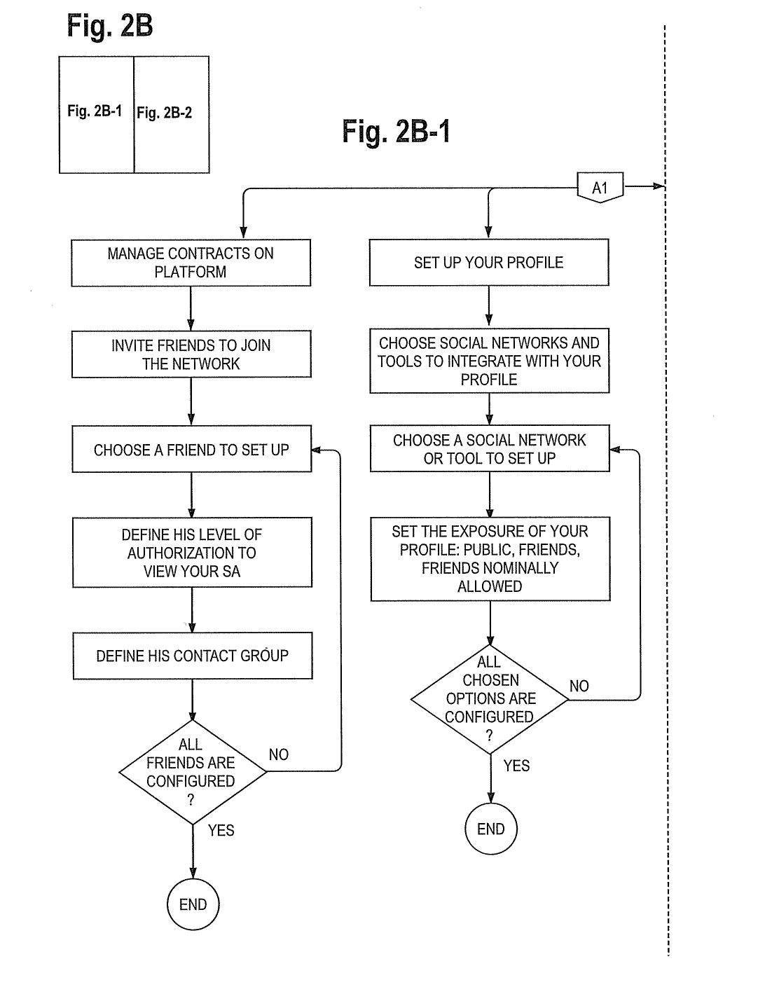

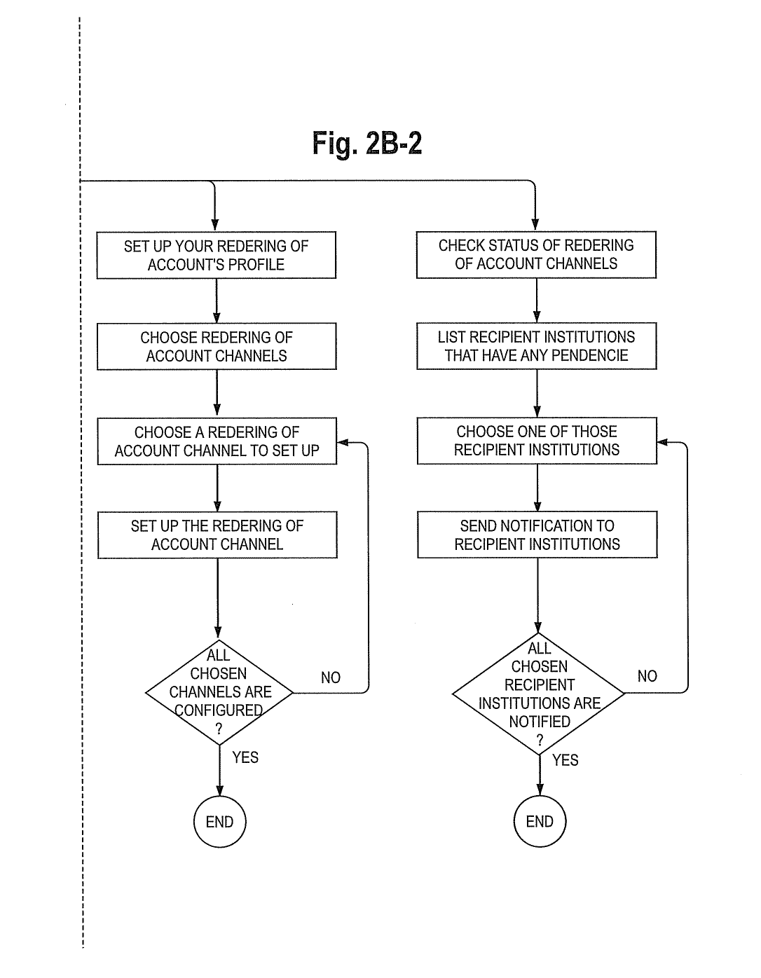

FIG. 2 presents the interactions of the Social Investor (A), who makes a Solidarity Award (10) which consists in the selection of an Awardee (B), who may or not be registered at the online platform and in the accomplishment of a social investment to a Recipient Institution (C), which may be indicated by the Awardee (B) or selected by the Social Investor (A).

In the case of the Awardee (B) not being registered at the online platform, a similarity-based search is made before the validation and the suggestion of similar records already registered at the platform is presented.

The Social Investor (A), upon accessing the online platform by means of login and password, may access the platform's ranking of Awardees (B), the platform's ranking of prizes or rewards, the platform's ranking of Recipient Institutions (C) and the platform's ranking of Social Investors (A).

Based on the visualization of the platform's ranking of Awardees (B), the Social Investor (A) selects an Awardee (B) to make an award, a prize or reward to accomplish the Solidarity Award and, finally, a Recipient Institution (C) to make the social investment, configuring the inseparable binomial ‘social investment and award’, defined herein as Solidarity Award (10). There is also the possibility of the Solidarity Award definition process beginning based on a prize or reward, or, still, based on a Recipient Institution (C) preferred by the Social Investor (A), but the choice of the Awardee (B) must occur in order for the correct definition of the Solidarity Award binomial.

The Social Investor (A) can also monitor, on the online platform, his/her prizes or rewards in progress and his/her Solidarity Awards, being able to visualize the ranking of his/her Awardees (B), the ranking of his/her prizes or rewards and the ranking of his/her Recipient Institutions (C).

The Social Investor (A) may make a search by Awardee B), visualizing the list of Spontaneous Awardees and Official Awardees to select one for the accomplishment of a Solidarity Award.

The Spontaneous Awardee is conceptualized within the scope of this document as one who has been registered by the Social Investor (A), being that said Awardee may (B) be of a public or private nature. In the case of private Awardees, the Social Investor (A) defines the contact groups who will have the right to access the profile of these private Awardees.

The official Awardee is the one who has been validated by internal processes as being of public interest and certified in relation to authenticity of the object or individual referenced by the latter.

For the registration of the Awardee (B) profile, any type of intellectual or artistic works (cinematographic, literary, musical and other types) may be indicated, as well as personalities or groups of individuals, artists of any nature, social organizations, companies and entities of any nature. The registration of the Awardee (B) profile is performed by the individual or corporate entity holder of the image rights or copyrights of the registered object.

The Social Investor (A) may conduct a search by prize or reward and select one of these prizes or rewards for allocation to a Recipient Institution (C) to accomplish the social investment, or, still, conduct a search by Recipient Institution (C) to define his/her choice to accomplish the Solidarity Award, which will be tied to the selection of an Awardee (B) due to the inseparability of the accomplishment of the social investment and the award.

The Social Investor (A) may, within the scope of the platform, manage the network contacts by means of invitations for new members, establishing the level of access to which each member will be entitled, such as, for example, the possibility of visualizing the instances of Solidarity Awards accomplished by this Social Investor (A).

The Social Investor (A) configures his/her profile so as to define the social networks and tools that will be used to disclose his/her Solidarity Awards, defining the degree of exposure of the contact.

Regarding the rendering of accounts of the Solidarity Awards performed for the Recipient Institutions (C), the Social Investor (A) must configure this Rendering of Account Channel (30), selecting those desired. The Social Investor (A) verifies the status of the Rendering of Account Channel (30), being authorized to list the Recipient Institutions (C) with pending items and send alerts to these Institutions.

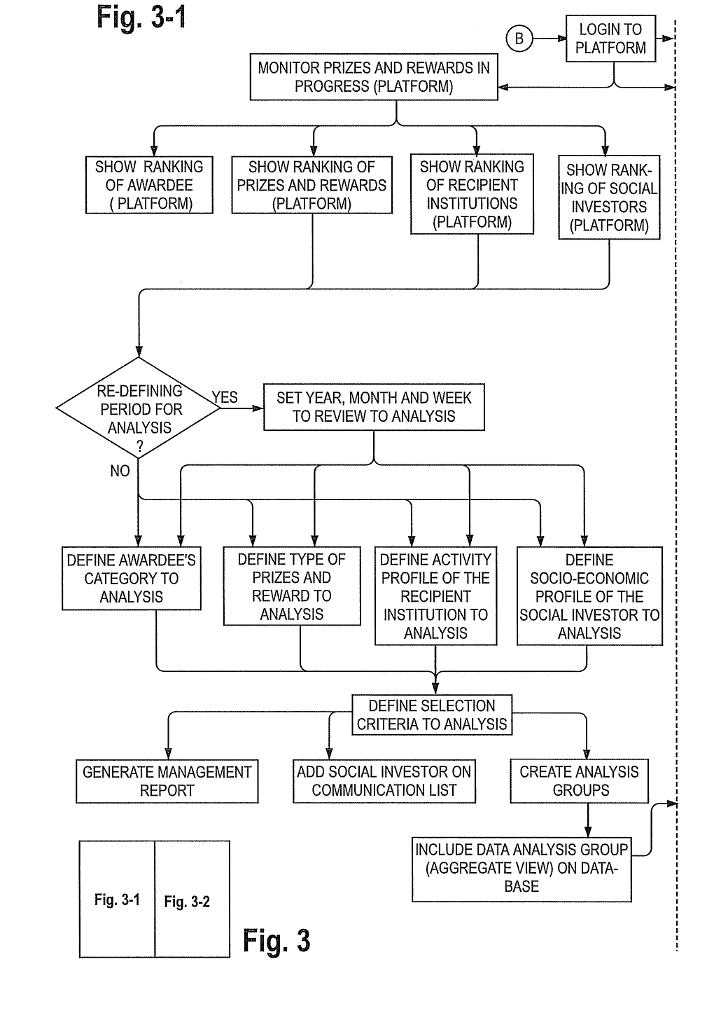

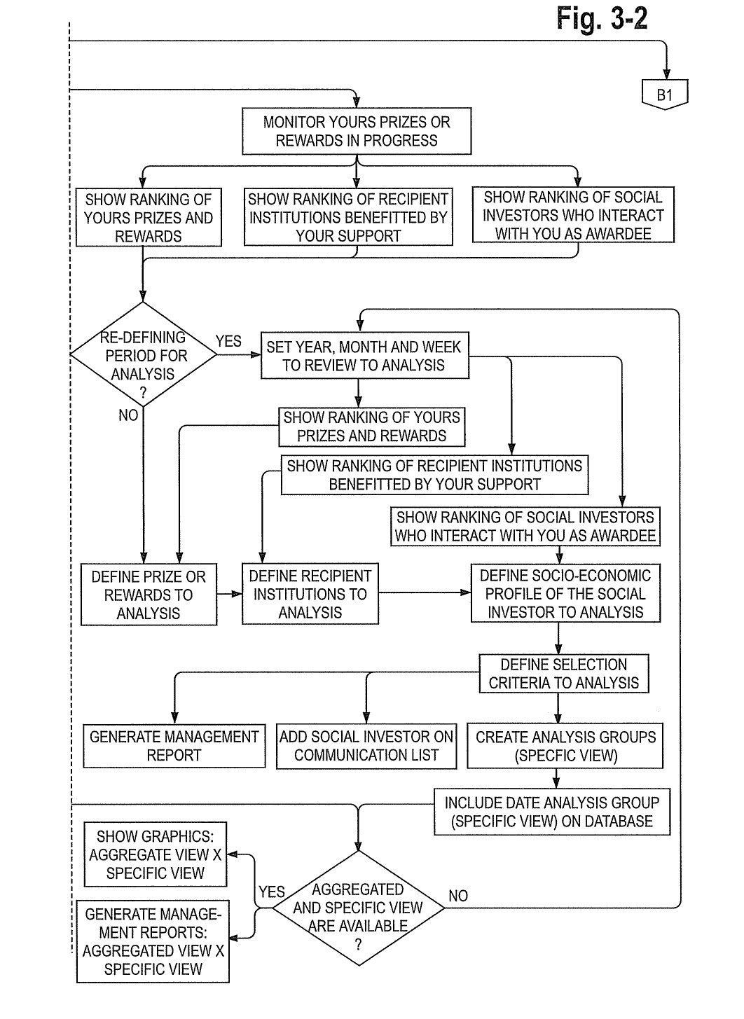

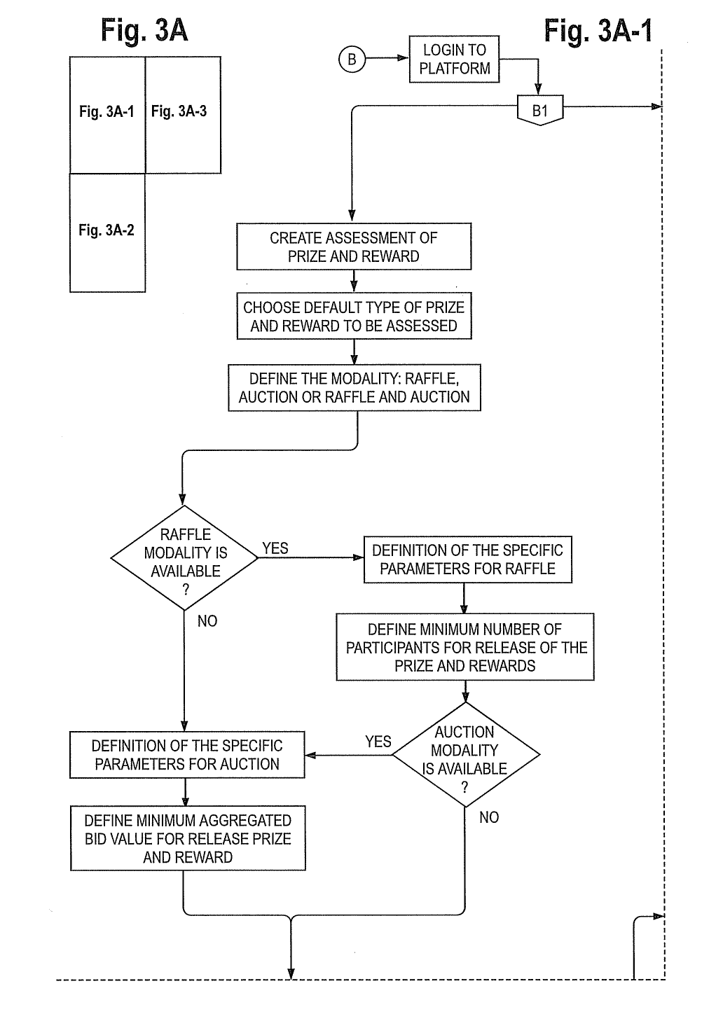

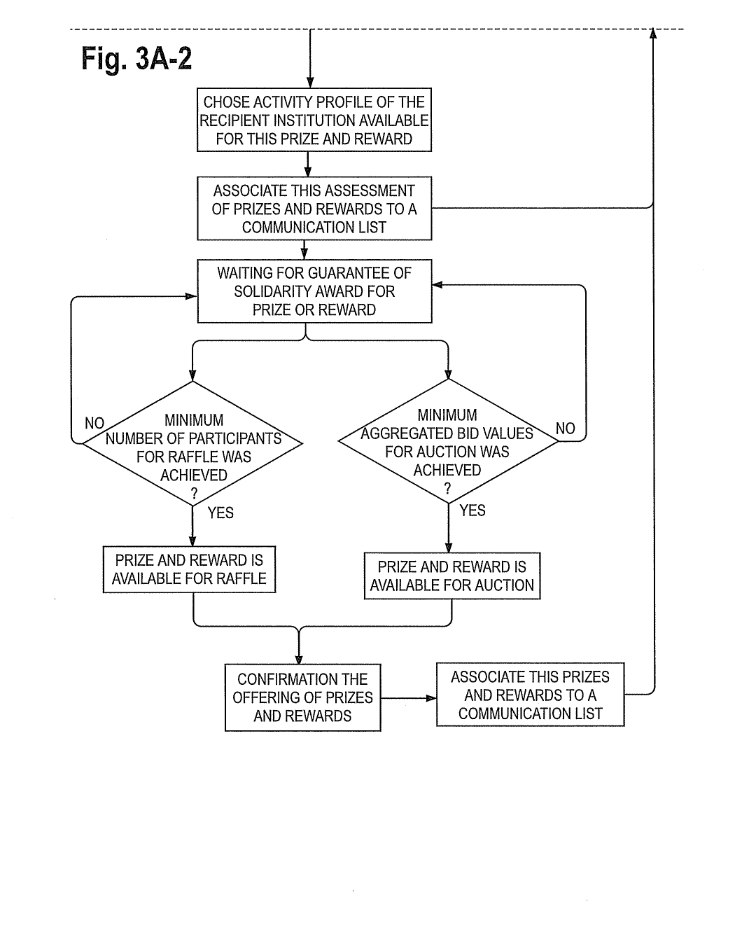

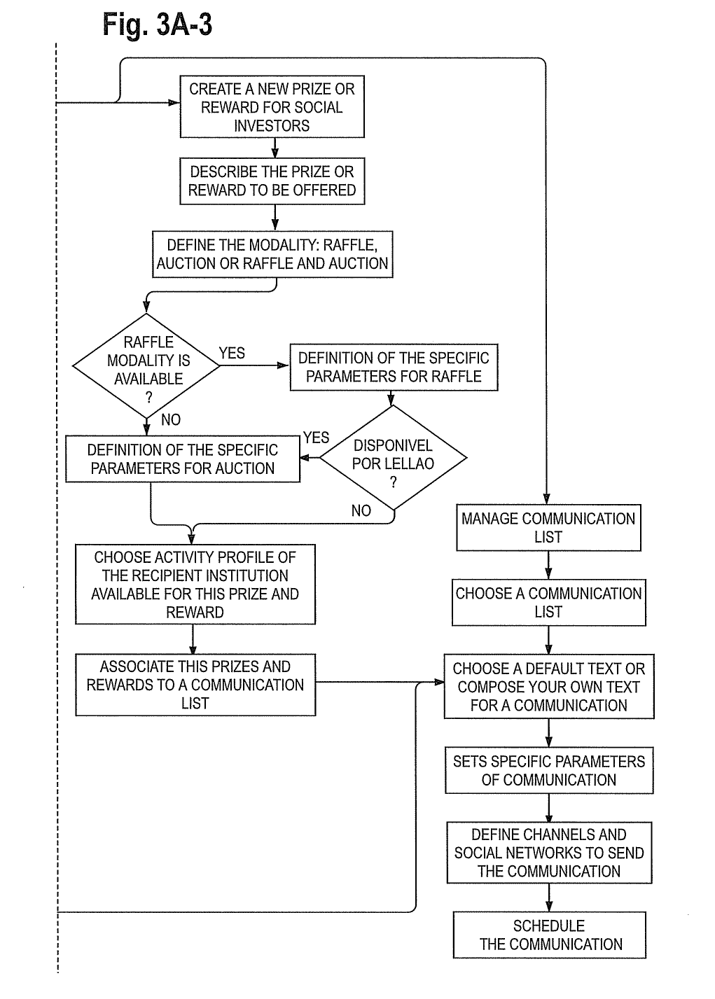

FIG. 3 presents the relationships established after entry to the online platform, by login and password, of the agent referred to as Awardee (B).

The Awardee (B) may monitor the prizes and rewards of the platform, visualizing the ranking of Awardees (B), the ranking of prizes or rewards, the ranking of Recipient Institutions (C) and the ranking of Social Investors (A).

This Awardee (B) may also monitor his/her prizes or rewards in progress, visualizing the ranking of his/her prizes or rewards, the ranking of Recipient Institutions (C) benefitted by his/her support and the ranking of Social Investors (A) who interact with this Awardee (B).

The Awardee (B), who offers a prize or reward under the assessment of the Social Investors (A) by means of the Offering of Prizes and Rewards Channel (20), has the possibility of assessing the performance by means of the Assessment of Prizes and Rewards Channel (21). For the assessment, the Awardee (B) may define the modality of the prize: raffle, auction or raffle and auction, with the definition of the specific parameters for each modality, minimum number of participants for release of the prize and/or minimum bid, and associate this to a communication list.

The Awardee (B) may optionally, within the scope of the online platform, be linked to the agent referred to as Institutional Area of Support to Awardees (D), which, through the Offering of Opportunity to Awardees Channel (40), creates or offers a new opportunity to an Awardee (B) who then offers a new prize or reward to the Social Investor (A) by means of the Offering of Prizes and Rewards Channel (20), describing the prize which he/she is offering and the modality of the prize: raffle, auction, or raffle and auction, and selecting the Recipient Institution (C) for this prize through the qualification for offering of prize or reward channel (11).

Optionally, the Awardee (B) may suggest an opportunity to the Institutional Area of Support to Awardees (D) to which said Awardee (B) is linked, using the Opportunity Suggestion Channel (41).

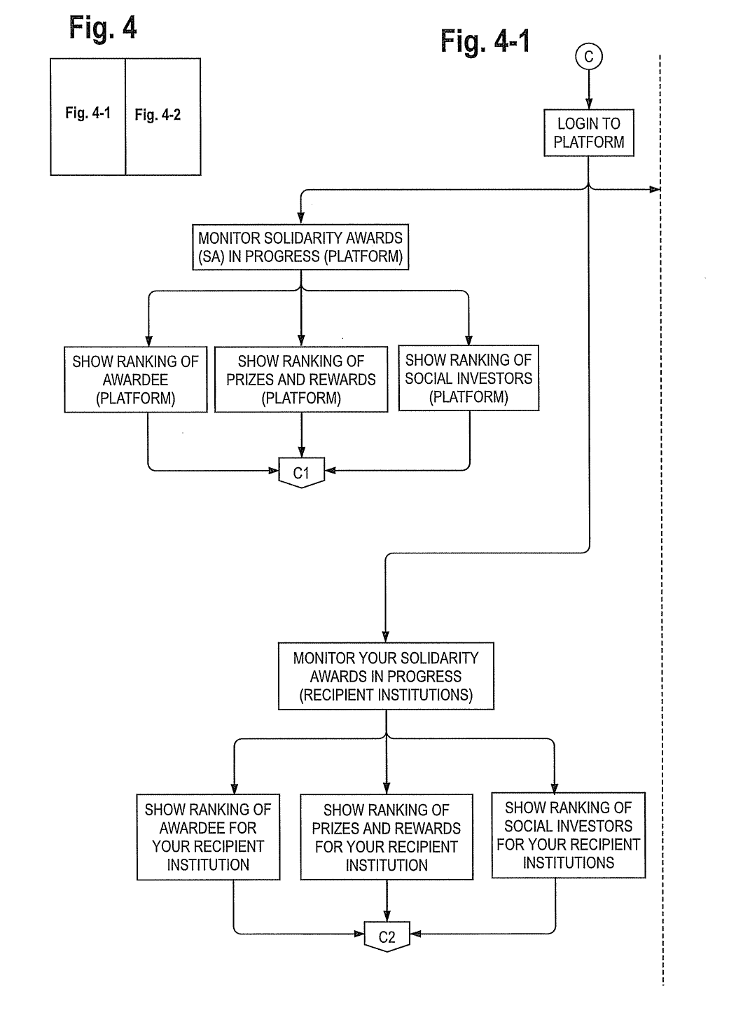

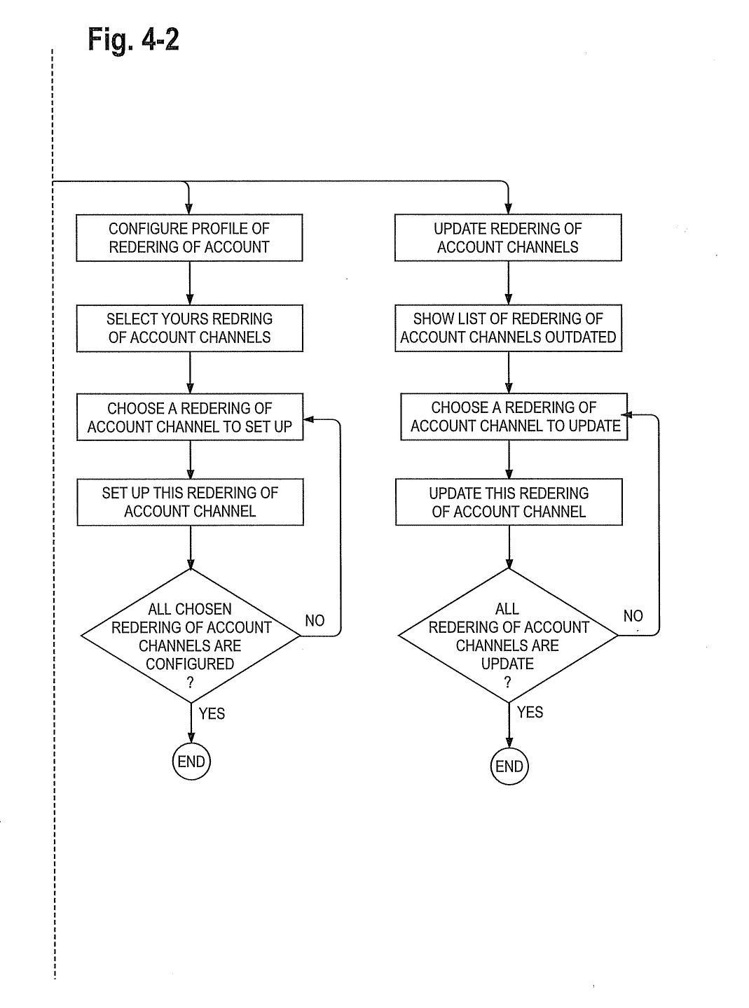

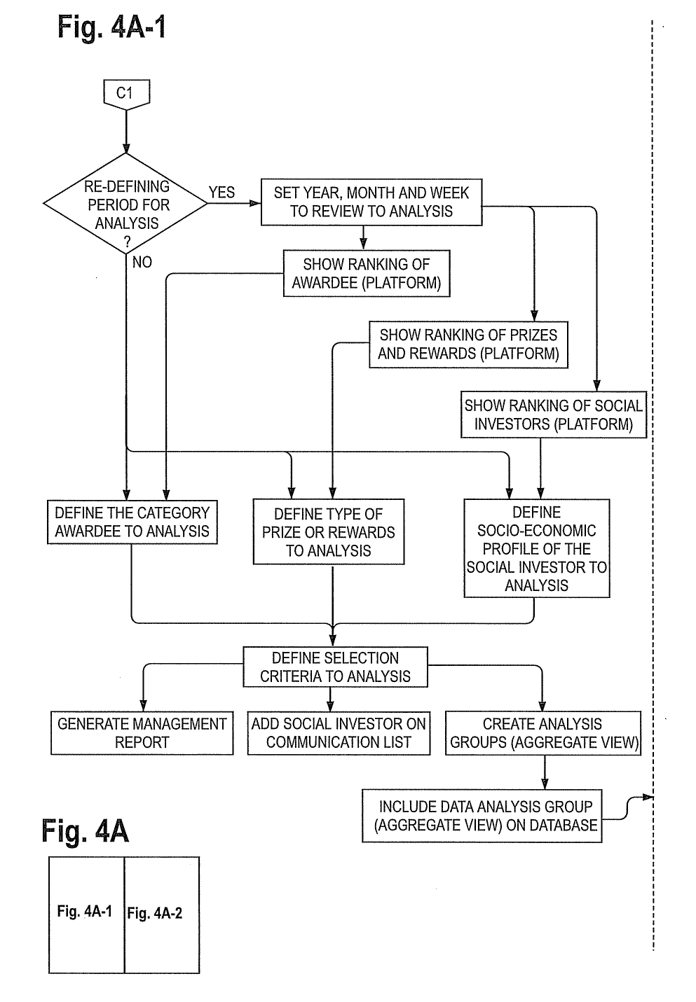

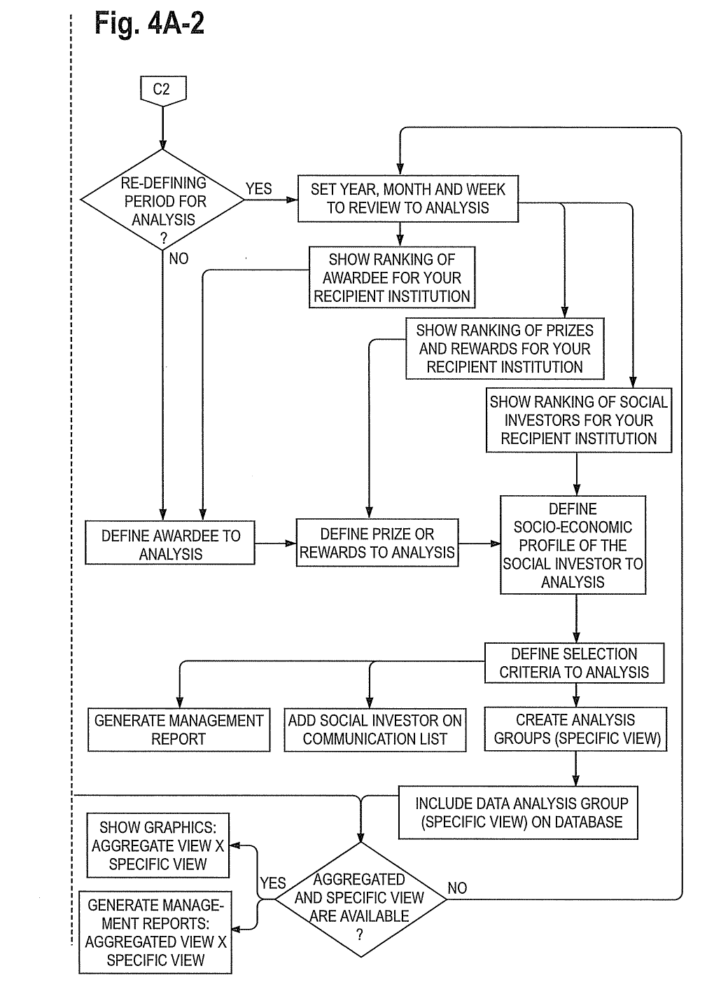

As presented in FIG. 4, the Recipient Institution agent (C) accesses the online platform by means of login and password, being able to visualize all the platform's Solidarity Awards related to a specific Recipient Institution (C), configure a profile for the rendering of account and/or update the Rendering of Account Channels (30).

The visualization of the entire platform's Solidarity Awards allows the Recipient Institution (C) to visualize the ranking of the platform's Awardees (B), the ranking of the platform's prizes and rewards, and the ranking of the platform's Social Investors (A), by establishing criteria for the filtering of this data, which may be based on temporality, Awardee category, type of prize or reward, Social Investor profile, and to generate management reports, create analysis groups and communication lists.

The visualization of Solidarity Awards related exclusively to the consulted Recipient Institution (C) allows the Recipient Institution (C) to visualize the ranking of Awardees (B) of this Recipient Institution (C), the ranking of prizes or rewards and the ranking of Social Investors (A), by establishing criteria for the filtering of this data which may be based on temporality, Awardee category, type of prize or reward, Social Investor profile, and to generate management reports, create analysis groups and communication lists.

For configuration of the rendering of account profile, the rendering of account channels are selected and all the channels are configured.

To update non-updated rendering of account channels, the non-updated channels are visualized and updated.

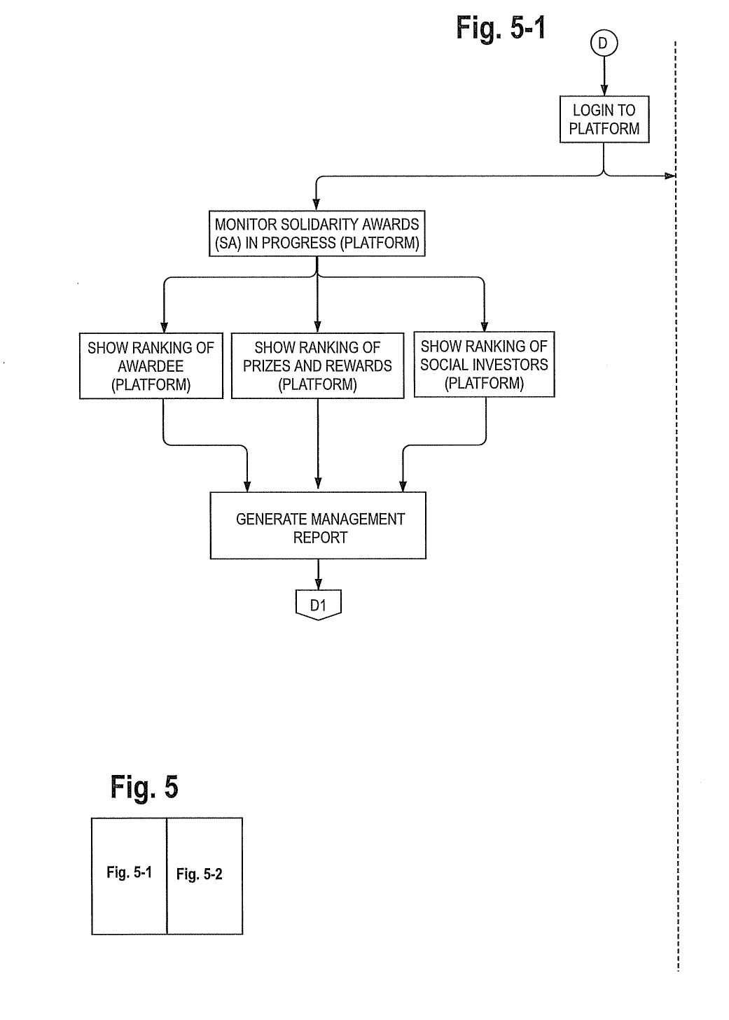

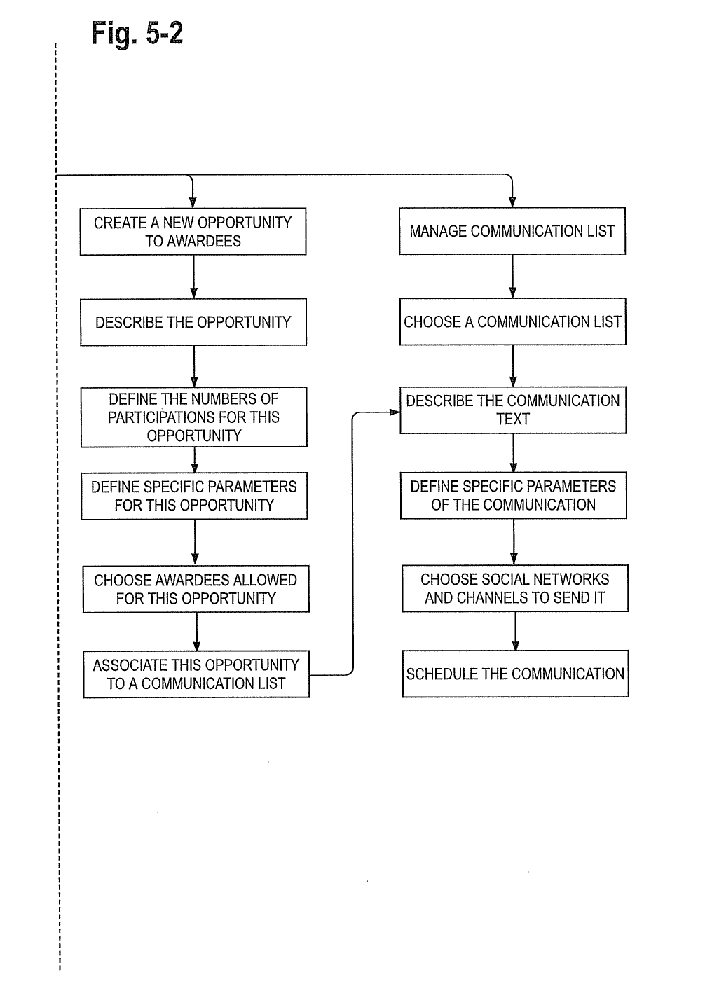

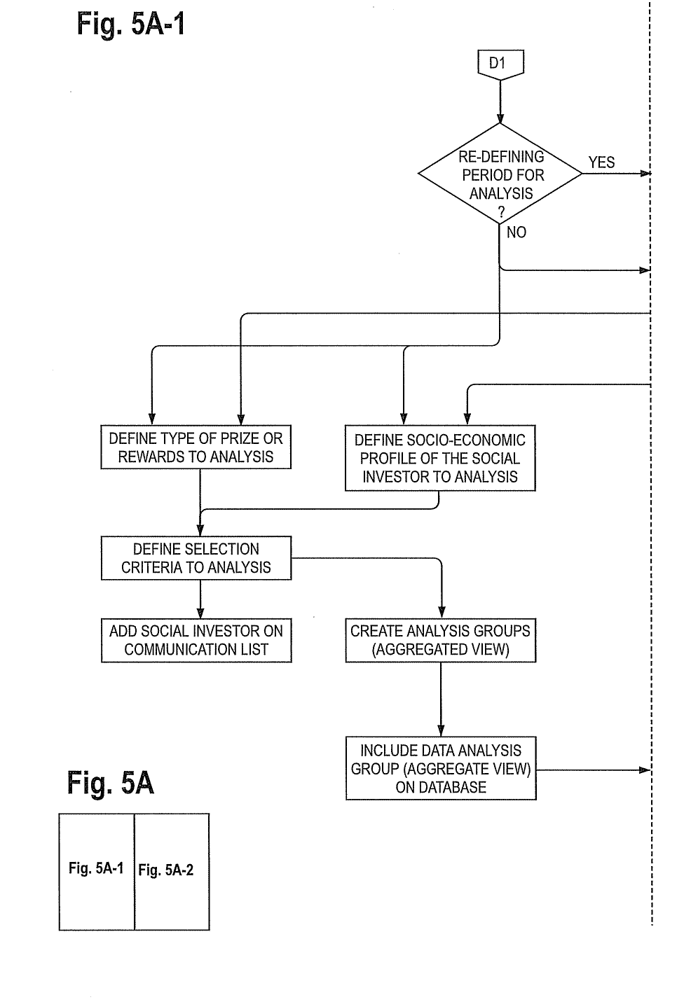

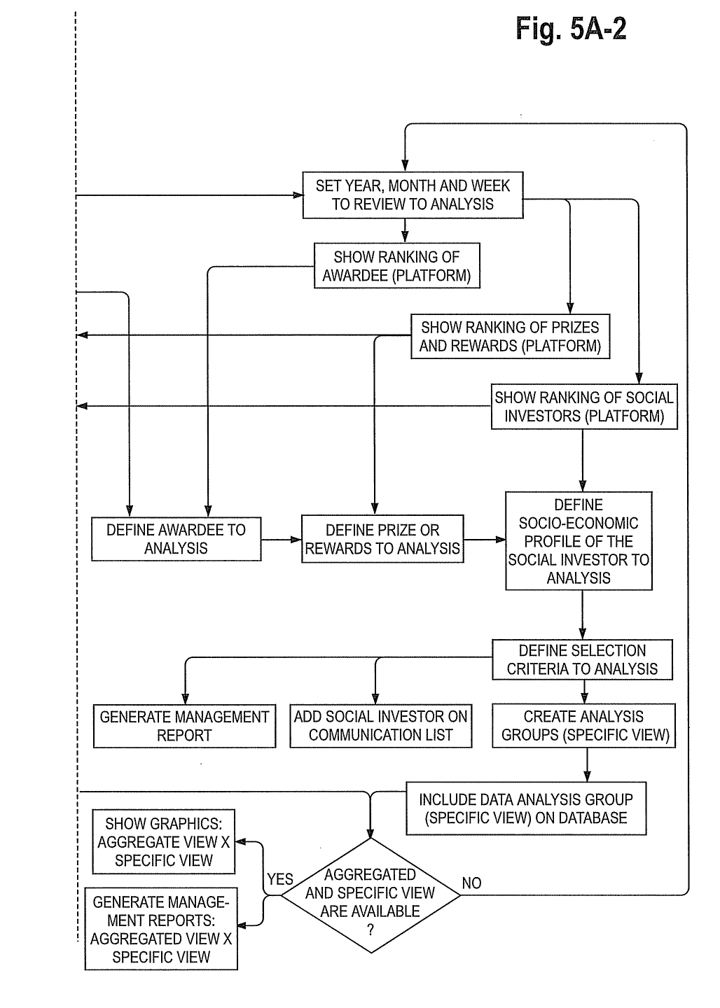

As presented in FIG. 5, the Institutional Area of Support to Awardees (D) Registering agent accesses the online platform, by means of login and password, and may visualize the instances of Solidarity Awards in progress on the platform, create and offer a new opportunity to an Awardee (B) or to a group of Awardees at his/her discretion through a specific channel (40), as well as manage the communication of these offered opportunities.

The visualization of the instances of Solidarity Awards in progress on the platform allows the Institutional Area of Support to Awardees (D) Registering Agent to visualize the platform's ranking of Awardees (B), the platform's ranking of prizes and rewards, and the platform's ranking of Social Investors (A), by establishing criteria for the filtering of this data which may be based on temporality, Awardee category, type of prize or reward, Social Investor (A) profile and to generate management reports, create analysis groups and communication lists.

For the creation of a new opportunity for the Awardee (B) through the Offering of Opportunity to Awardees Channel (40), the Institutional Area of Support to Awardees (D) Registering Agent describes the opportunity that is being offered, defines the number of participants in this opportunity, the specific related parameters, selects the Awardees (B) qualified for this opportunity and associates the opportunity to a communications list, selecting the social channels and networks to which the communication is to be sent.

1. SYSTEM FOR THE MANAGEMENT OF INTERACTION CHANNELS BETWEEN SOCIAL INVESTORS, AWARDEES AND RECIPIENT INSTITUTIONS comprising an online platform that includes a remote access server which stores a database referent to registration of system user profiles and a site with access by means of a communication network requiring login and password, where each user accesses his/her respective profile and/or visualizes the interactions related to his/her user profile, said profiles being defined as Social Investor (A), Awardee (B) and Recipient Institution (C) all of whom perform interactions through channels provided by the platform to accomplish a Solidarity Award.

2. SYSTEM FOR THE MANAGEMENT OF INTERACTION CHANNELS BETWEEN SOCIAL INVESTORS, AWARDEES AND RECIPIENT INSTITUTIONS comprising an online platform that includes a remote access server which stores a database referent to registration of system user profiles and a site with access by means of a communication networks requiring login and password, where each user accesses his/her respective profile and/or visualizes the interactions related to his/her user profile, said profiles being defined as Social Investor (A), Awardee (B), Recipient Institution (C) and Institutional Area of Support to Awardees (D), all of whom perform interactions through channels provided by the platform to accomplish a Solidarity Award.

3. SYSTEM FOR THE MANAGEMENT OF INTERACTION CHANNELS BETWEEN SOCIAL INVESTORS, AWARDEES AND RECIPIENT INSTITUTIONS, according to claim No. 1, wherein the Solidarity Award further comprising a single transaction established between the Social Investor (A), the Awardee (B) and the Recipient Institution (C).

4. METHOD FOR THE MANAGEMENT OF INTERACTION CHANNELS BETWEEN SOCIAL INVESTORS, AWARDEES AND RECIPIENT INSTITUTIONS comprising:
a) Registering a plurality of agents for access to the online platform with the creation of a specific profile—Social Investor (A), Awardee (B) or Recipient Institution (C);
b) Registering data from each of the plurality of agents on a database;
c) An agent of the plurality of agents accessing the online platform by means of login and password to access the respective profile and/or visualize the interactions related to his/her user profile;
d) The Social Investor (A) and Recipient Institution (C) interacting through the Solidarity Award Channel (10), where said Social Investor (A) accomplishes a social investment in favor of a Recipient Institution (C) previously registered at the online platform and which may be indicated by the Awardee (B) or selected by the Social Investor (A), and concomitantly this Social Investor (A) uses the Solidarity Award Channel (10) to interact with a Awardee (B) to dedicate an award;
e) The Social Investor (A) interacting exclusively with the Recipient Institution (C) by means of the Rendering of Account and Acknowledgement Channel (30), where the Recipient Institution (C) sends the consideration of the social investment made by the Investor (A); and
f) The Social Investor (A) interacting with the Awardee (B) by means of an Offering of Prizes and Rewards Channel (20), where the Awardee (B) offers to Social Investors (A) a prize or reward to be disputed by the Social Investors (A) in function of their respective instances of Solidarity Awards that comply with the specific prize or reward rules defined by the Awardee (B).

5. METHOD FOR THE MANAGEMENT OF INTERACTION CHANNELS BETWEEN SOCIAL INVESTORS, AWARDEES AND RECIPIENT INSTITUTIONS, according to claim No. 4, further comprising registering of an agent for Institutional Area of Support to Awardees (D).

6. METHOD FOR THE MANAGEMENT OF INTERACTION CHANNELS BETWEEN SOCIAL INVESTORS, AWARDEES AND RECIPIENT INSTITUTIONS, according to claim No. 4, wherein the registration of the user profiles (A, B, C and D) further comprising validating at least some of the user profiles established by the online platform, by acceptance of specific adhesion conditions.

7. METHOD FOR THE MANAGEMENT OF INTERACTION CHANNELS BETWEEN SOCIAL INVESTORS, AWARDEES AND RECIPIENT INSTITUTIONS, according to claim No. 4, wherein the interaction between the Awardee (B) and the Recipient Institution (C) further comprises Offering of Prizes and Rewards (20), where the Awardee (B) chooses to define that the participation of Social Investors (A) for a certain prize or reward is restricted to the selection of a certain group of Recipient Institutions (C), said interaction represented by the unidirectional interaction Qualification of the Offering of Prize or Reward (11).

8. METHOD FOR THE MANAGEMENT OF INTERACTIONS CHANNELS BETWEEN SOCIAL INVESTORS, AWARDEES AND RECIPIENT INSTITUTIONS, according to claim No. 4, further comprising the Awardee (B) relating an offer of the Social Investors (A) with an Offering of Prizes and Rewards Channel (20) through the Assessment of Prizes and Rewards Channel (21).

9. METHOD FOR THE MANAGEMENT OF INTERACTION CHANNELS BETWEEN SOCIAL INVESTORS, AWARDEES, AND RECIPIENT INSTITUTIONS, according to claim No. 8, further comprising the Social Investor (A) requiring a minimum volume of Solidarity Award instances for a certain prize or reward proposed in the Offering of Prizes and Rewards Channel (20) through the Guarantee of Solidarity Award for Prize or Reward Channel (22).

10. METHOD FOR THE MANAGEMENT OF INTERACTION CHANNELS BETWEEN SOCIAL INVESTORS, AWARDEES AND RECIPIENT INSTITUTIONS, according to claim No. 4, further comprising linking the Awardee (B) or a group of Awardees to the agent referred to as Institutional Area of Support to Awardees (D).

11. METHOD FOR THE MANAGEMENT OF INTERACTION CHANNELS BETWEEN SOCIAL INVESTORS, AWARDEES AND RECIPIENT INSTITUTIONS, according to claim No. 10, further comprising the Institutional Area of Support to Awardees (D) creating or offering a new opportunity to an Awardee (B) through the Offering of Opportunity to Awardees Channel (40).

12. METHOD FOR THE MANAGEMENT OF INTERACTION CHANNELS BETWEEN SOCIAL INVESTORS, AWARDEES AND RECIPIENT INSTITUTIONS, according to claim No. 10, further comprising the Awardee (B) offering a new prize or reward to the Social Investor (A) through the Offering of Prizes and Rewards Channel (20) where he/she describes the prize that is being offered, the modality of the prize which may be a raffle, auction or raffle and auction, and the selection of the Recipient Institution (C) for this prize through the qualification for offering of prize or reward channel (11).

13. METHOD FOR THE MANAGEMENT OF INTERACTION CHANNELS BETWEEN SOCIAL INVESTORS, AWARDEES AND RECIPIENT INSTITUTIONS, according to claim No. 10, further comprising the Awardee (B) suggesting opportunities of his/her interest to the Institutional Area of Support to Awardees (D) through the Opportunity Suggestion Channel (41) which generates the obligation of offering a prize or reward to the Social Investors (A) through the Offering of Prizes and Rewards Channel (20).

14. METHOD FOR THE MANAGEMENT OF INTERACTION BETWEEN SOCIAL INVESTORS, AWARDEES AND RECIPIENT INSTITUTIONS, according to claim No. 4, further comprising the online platform providing management analysis tools (50).

15. METHOD FOR THE MANAGEMENT OF INTERACTION CHANNELS BETWEEN SOCIAL INVESTORS, AWARDEES AND RECIPIENT INSTITUTIONS, according to claim No. 4, further comprising the Social Investor (A) conducting a search by Awardee (B) visualizing the list of Spontaneous Awardees registered by the Social Investor (A), being that said Awardee may (B) be public or private.

16. METHOD FOR THE MANAGEMENT OF INTERACTION CHANNELS BETWEEN SOCIAL INVESTORS, AWARDEES AND RECIPIENT INSTITUTIONS, according to claim No. 4, further comprising the Social Investor (A) conducting a search by Awardee (B) visualizing the list of Official Awardees validated by internal processes as being of public interest and certified as to the authenticity of the object or individual to which it is referenced.
